(19) United States
(12) Patent Application Publication
(10) Pub. No.: US 2019/0090662 A1
(43) Pub. Date: Mar. 28, 2019

(54) BUBBLE GLOW CART AND OTHER CARTS

(71) Applicant: LightUpToys.com LLC, Sellersburg, IN (US)

(72) Inventors: Joshua C. Kelly, Sellersburg, IN (US); Max Armendariz Lalama, Georgetown, IN (US); Macualay Bruton, Louisville, KY (US)

(21) Appl. No.: 15/713,707

(22) Filed: Sep. 25, 2017

(51) Int. Cl. A47F 5/10; A47F 7/00; B62B 3/02; B62B 5/04; A63H 33/22

(52) U.S. Cl. CPC A47F 5/108; A47F 7/00; A47F 11/10; B62B 5/04; A63H 33/22; B62B 3/02

(57) ABSTRACT

A bubble cart is described and disclosed herein. The bubble cart including a point of purchase display system for the display and/or demonstration of products, including bubble toy products.

### COMPONENTS

Bubble Glow Cart 1

carriage and support structure 2

external display hood 3

zones to support products and/or SKUs 4

### DRAWINGS

FIG. 1 shows a bubble glow cart with the hood off. In this embodiment, the hood would be placed on the carriage and support structure. It is also anticipated that the carriage and support structure can incorporate wheels underneath and/or be placed directly on the floor or a flat surface such as a table top.

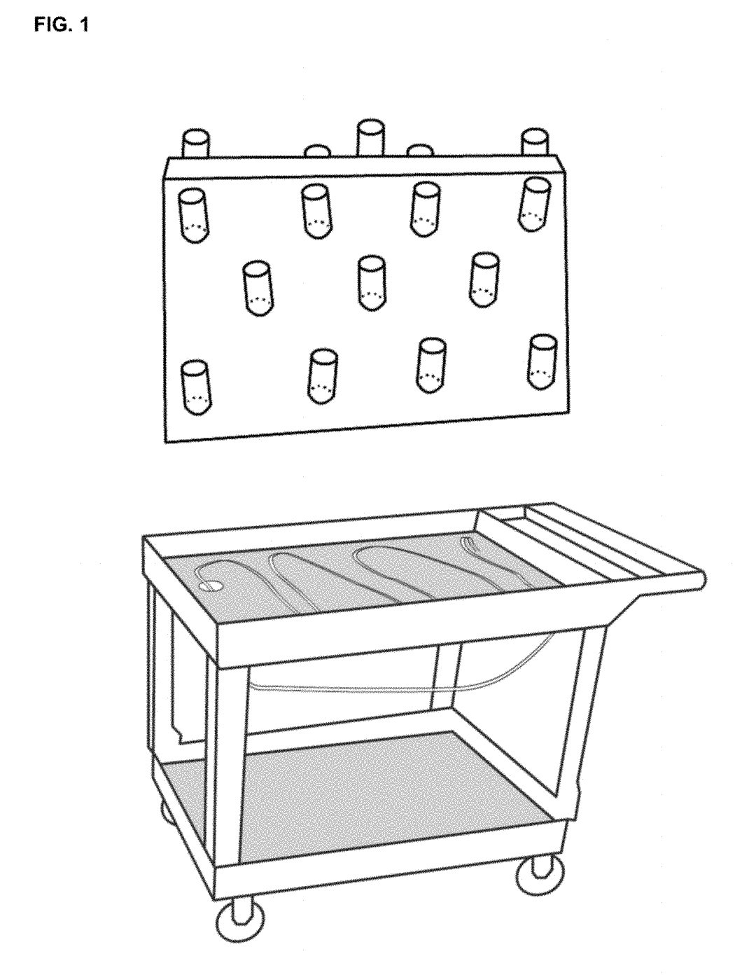

FIG. 2 shows the bubble glow cart.

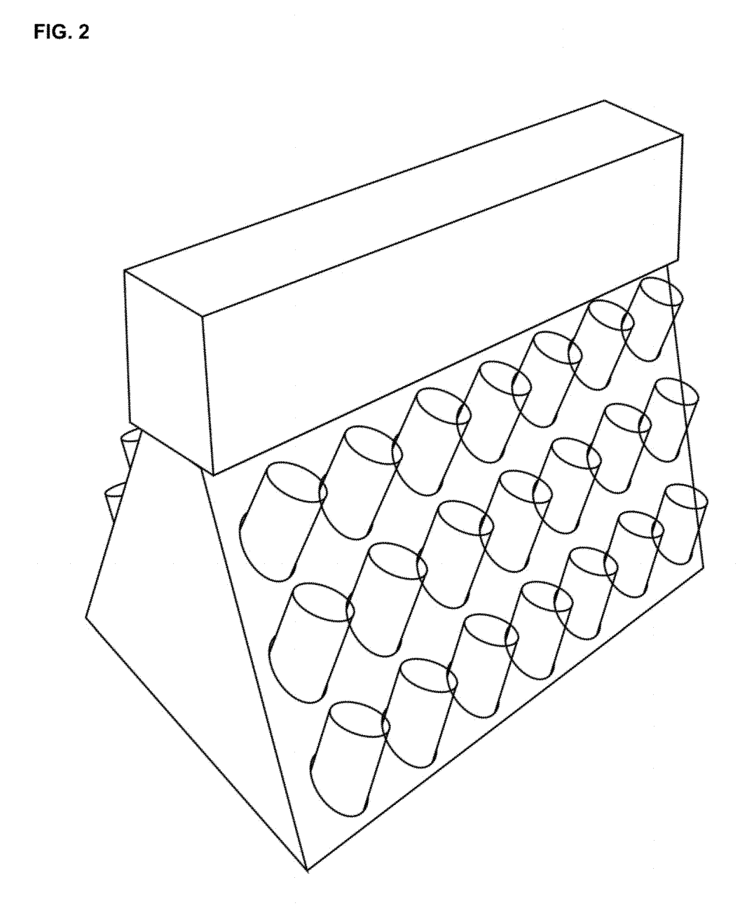

FIG. 3 shows the bubble glow cart with typical dimension call outs, though others sizes are anticipated, and this is for demonstration purposes only.

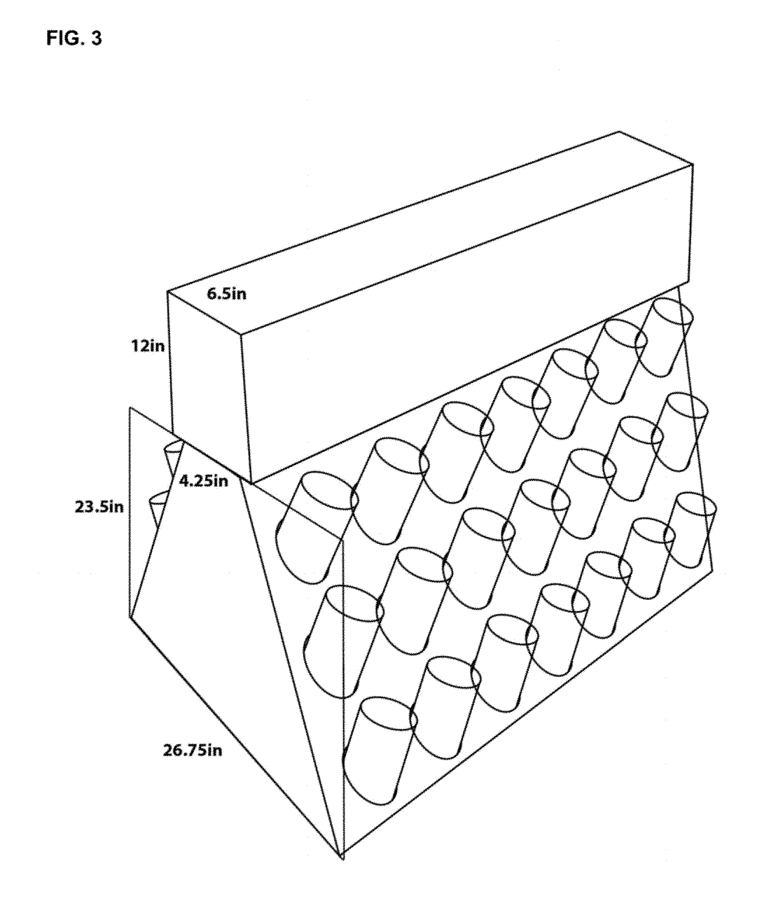

### SUMMARY

The Bubble Glow Cart is a point of purchase display system for the display and/or demonstration of products and/or bubble toy products. These displayable products can manufactured by Lightuptoys.com, but are not limited to products manufactured by any specific manufacturer.

The Bubble Glow Cart that can be mobile and/or stationary. It can be wheeled into position and have the wheels locked in place to secure the cart so it doesn't roll. There can be a carriage and support structure, and there can be an external display shell that fits over and mates with the carriage and support structure. The external display shell can lock securely to the carriage and support structure, and there can be different external display shells that can be interchangeable, and each external display shell can either be customized for a specific SKU or type of product or can be customized for a specific class of products or product lines, or the external display shell can be of a generalized design and/or even a universal design to accommodate any type of product. There can be attachments to allow each SKU or type of product to attach to the external display shell. The SKUs or products can be securely attached so there can be no movement, or products can have limited movement, or products can be tethered to permit removal from a customized or generalized docking area on the external display shell.

The shape of the shell or external display hood can be rectangular, triangular, trapezoidal, curved, and/or any number of geometric shapes or combinations of geometric shapes. It can be in whole or in part: opaque, transparent, and/or translucent, with different lighting and/or lighting effects in at least one zone and/or portion of the display hood. It can be in whole or in part hollow and/or solid. There can be lighting internally as well as externally. External lighting can be lighting supported via mechanical extensions emanating from the display shell to project light back at items being displayed. The extensions can be variably positionable. There can be multiple sections including but not limited to a base section of at least one geometric shape and at least one signage section of at least one geometric shape, and at least one signage section can attach to at least one base section.

The Bubble Glow Cart can also be a complete display shell with wheels located underneath that can allow the entire cart to roll into position. The Bubble Glow Cart can also have no wheels, and be made to be free standing on the floor or on a flat surface such as a table.

The bubble glow cart is designed to highlight toy features such as neon glow, generalized luminescence and/or lighting effects, lighting sequences and patterns, bubble production, sound production, and synchronization of two or more features.

The bubble glow cart can have any number of featured effects in addition to the features of the toys being displayed. There can be any of the following in any combination: at least one lighting effect, at least one sound effect, at least one kinetic motion effect that can be motorized or powered by other means such as stored energy in a spring or kinetic and/or potential energy, pressurized air, or via human interaction, fluid effects, bubbles, and/or projections of light.

The bubble glow cart can contain a microprocessor and/or controller that can control the lights and sounds and features, kinetic features and/or other effects requiring control using electricity and/or mechanisms.

The bubble glow cart can be connected to the internet and/or a network, wireless or via cable, fiber optic, acoustic, to permit communication with a central computer and/or a website, thus allowing updates to alter interaction with the public, store management, or customers.

The bubble glow cart can be powered by wall current, namely US and/or European power, and/or it can be battery powered with either rechargeable or non-rechargeable batteries. It the batteries are rechargeable, there can either be incorporated within a built-in charger or charging system or an external charger can be used.

The bubble glow cart can provide power to SKUs or products being displayed and/or demonstrated. This can entail turning on or off any number of products to facilitate any dramatic effect that can draw attention and attract people to the products being displayed and/or demonstrated.

At least one “show me” feature can cause at least one SKU or product to demonstrate at least one product feature.

At least one “show me” feature can cause at least one resident show or pattern to be executed on the bubble glow cart.

There can be proximity sensing and/or triggering by pressing at least one button to cause at least one demonstration or show to play and/or execute.

A remote control or hand controller and/or “clicker” can also be used to cause at least one demonstration or show to play and/or execute.

A mobile device can also be used to control at least one demonstration or show to play and/or execute.

Various embodiments of this invention can or may include currently or in the future a cart with at least one of the following types of products and displays:

a) Projection toys (including but not limited to wands, swords, canes, spinners, lanyards, and cups) that project images outward and/or inward are displayed on a cart and which toys and products can be either controlled by remote mechanism or other type of remote signal or mechanism to turn on or off or sequence the toy or product and the cart can be designed to enhance the experience or help improve the audio and/or visional sound, display, product display, and/or images displayed by reflection, mirror, sound system, added lights, electricity, or other display methods, features, accessories, or additions to cart to enhance the display;

b) Bubble toys making bubbles displayed on cart and the product or toy either being controlled by remote mechanism or signal to turn on or off or sequence the toy(s) or Product(s) and the cart being designed to enhance the experience or help improve the audio and/or visional sound and/or images displayed, and products or toys displayed, by reflection, mirror, sound system, added lights, supplying bubble solution or other liquid, bins, or other display methods, features, accessories, or additions;

c) Build a Sword—the cart providing parts bins displayed on the cart and the cart designed to enhance the experience or help improve the audio and/or visional sound and/or display, or images displayed by reflection, mirror, sound system, added lights, bins, or other display methods, accessories, or additions;

d) Spinners, Create A Light, and other light show toys that create light patterns, have create a light play patterns, project images outward and/or inward and/or display 3d animation (Like the LUT animated lanyards do) displayed and either being controlled by remote mechanism or other signal to turn on or off or other sequence and the cart designed to enhance the experience or help improve the audio and/or visional sound and/or images displayed by reflection, mirror, sound system, added lights, or other display methods, accessories, or additions;

e) Animated Lanyards, headbands, hats, glasses, eyewear, cell phone cases, jewelry, cups, and any other toys or products—that can be projecting animated images or sequences outward and/or

f) inward, displayed on cart and can be controlled by remote mechanism or other types of signal to turn on or off or sequence(s) and the cart designed to enhance the experience or help improve the audio and/or visional sound, display, product display, and/or images displayed by reflection, mirror, sound system, added lights, or other display methods, accessories, features, or additions;

f) Role play toys and accessories such as for example non-shooting sound making toys and guns, wrist non-shooting weapons being displayed with the cart including similar features to those described in a-e above.

g) All above embodiments may include motion or other sensor or detection associated with the cart and the product display, for example the motion activating at least one toy on the display cart.

h) All above embodiments may include specialized attachment devices or cart features to hold in place and/or trigger the toys or products.

What is claimed:

1) The Bubble Glow Cart comprises a point of purchase display system for the display and/or demonstration of products and/or bubble toy products.

2) The Bubble Glow Cart of claim 1 can be mobile and/or stationary.

3) The Bubble Glow Cart of claim 1 can be wheeled into position and have the wheels locked in place to secure the cart so it doesn't roll.

4) The Bubble Glow Cart of claim 1 further comprises at least one of a carriage and support structure, an external display shell that fits over and mates with the carriage and support structure.

5) The Bubble Glow Cart of claim 1 further comprises that the said external display shell locks securely to the carriage and support structure.

6) The Bubble Glow Cart of claim 1 further comprises different external display shells that are interchangeable and can be removably attached.

7) The Bubble Glow Cart of claim 1 further comprises that each external display shell is customized for a specific SKU or type of product or customized for a specific class of products or product lines, or the external display shell is of a generalized design and/or even a universal design to accommodate any type of product.

8) The Bubble Glow Cart of claim 1 further comprises attachments to allow each SKU or type of product to attach to the external display shell.

9) The Bubble Glow Cart of claim 1 further comprises that the SKUs or products can be securely attached so there can be no movement, or products can have limited movement, or products can be tethered to permit removal from a customized or generalized docking area on the external display shell.

10) The Bubble Glow Cart of claim 1 further comprises at least one of the following:
that the shape of the shell or external display hood can be rectangular, triangular, trapezoidal, curved, and/or any number of geometric shapes or combinations of geometric shapes. It can be in whole or in part: opaque, transparent, and/or translucent, with different lighting and/or lighting effects in at least one zone and/or portion of the display hood. It can be in whole or in part hollow and/or solid. There can be lighting internally as well as externally. External lighting can be lighting supported via mechanical extensions emanating from the display shell to project light back at items being displayed. The extensions can be variably positionable. There can be multiple sections including but not limited to a base section of at least one geometric shape and at least one signage section of at least one geometric shape, and at least one signage section can attach to at least one base section;
The Bubble Glow Cart can be a complete display shell with wheels located underneath that can allow the entire cart to roll into position.
The Bubble Glow Cart can also have no wheels, and be made to be free standing on the floor or on a flat surface such as a table;
The bubble glow cart is designed to highlight toy features such as neon glow, generalized luminescence and/or lighting effects, lighting sequences and patterns, bubble production, sound production, and synchronization of two or more features;
The bubble glow cart can have any number of featured effects in addition to the features of the toys being displayed. There can be any of the following in any combination: at least one lighting effect, at least one sound effect, at least one kinetic motion effect that can be motorized or powered by other means such as stored energy in a spring or kinetic and/or potential energy, pressurized air, or via human interaction, fluid effects, bubbles, and/or projections of light;
The bubble glow cart can contain a microprocessor and/or controller that can control the lights and sounds and features, kinetic features and/or other effects requiring control using electricity and/or mechanisms;
The bubble glow cart can be connected to the internet and/or a network, wireless or via cable, fiber optic, acoustic, to permit communication with a central computer and/or a website, thus allowing updates to alter interaction with the public, store management, or customers;
The bubble glow cart can be powered by wall current, namely US and/or European power, and/or it can be battery powered with either rechargeable or non-rechargeable batteries. It the batteries are rechargeable, there can either be incorporated within a built-in charger or charging system or an external charger can be used;
The bubble glow cart can provide power to SKUs or products being displayed and/or demonstrated. This can entail turning on or off any number of products to facilitate any dramatic effect that can draw attention and attract people to the products being displayed and/or demonstrated;
At least one “show me” feature can cause at least one SKU or product to demonstrate at least one product feature;
At least one “show me” feature can cause at least one resident show or pattern to be executed on the bubble glow cart;
There can be proximity sensing and/or triggering by pressing at least one button to cause at least one demonstration or show to play and/or execute;
A remote control or hand controller and/or “clicker” can also be used to cause at least one demonstration or show to play and/or execute;
A mobile device can also be used to control at least one demonstration or show to play and/or execute.

11. Various embodiments of this invention can or may include currently or in the future a cart with at least one of the following types of products and displays:
a) Projection toys (including but not limited to wands, swords, canes, spinners, lanyards, and cups) that project images outward and/or inward are displayed on a cart and which toys and products can be either controlled by remote mechanism or other type of remote signal or mechanism to turn on or off or sequence the toy or product and the cart can be designed to enhance the experience or help improve the audio and/or visional sound, display, product display, and/or images displayed by reflection, mirror, sound system, added lights, electricity, or other display methods, features, accessories, or additions to cart to enhance the display;
b) Bubble toys making bubbles displayed on cart and the product or toy either being controlled by remote mechanism or signal to turn on or off or sequence the toy(s) or Product(s) and the cart being designed to enhance the experience or help improve the audio and/or visional sound and/or images displayed, and products or toys displayed, by reflection, mirror, sound system, added lights, supplying bubble solution or other liquid, bins, or other display methods, features, accessories, or additions;
c) Build a Sword—the cart providing parts bins displayed on the cart and the cart designed to enhance the experience or help improve the audio and/or visional sound and/or display, or images displayed by reflection, mirror, sound system, added lights, bins, or other display methods, accessories, or additions;
d) Spinners, Create A Light, and other light show toys that create light patterns, have create a light play patterns, project images outward and/or inward and/or display 3d animation (Like the LUT animated lanyards do) displayed and either being controlled by remote mechanism or other signal to turn on or off or other sequence and the cart designed to enhance the experience or help improve the audio and/or visional sound and/or images displayed by reflection, mirror, sound system, added lights, or other display methods, accessories, or additions;
e) Animated Lanyards, headbands, hats, glasses, eyewear, cell phone cases, jewelry, cups, and any other toys or products—that can be projecting animated images or sequences outward and/or inward, displayed on cart and can be controlled by remote mechanism or other types of signal to turn on or off or sequence(s) and the cart designed to enhance the experience or help improve the audio and/or visional sound, display, product display, and/or images displayed by reflection, mirror, sound system, added lights, or other display methods, accessories, features, or additions;
f) Role play toys and accessories such as for example non-shooting sound making toys and guns, wrist non-shooting weapons being displayed with the cart including similar features to those described in a-e above.
g) All above embodiments may include motion or other sensor or detection associated with the cart and the product display, for example the motion activating at least one toy on the display cart.
h) All above embodiments may include specialized attachment devices or cart features to hold in place and/or trigger the toys or products.

12. The invention of claim 1 further comprising supplemental electronics producing at least one signal, said supplemental electronics comprising at least one of RFID, GPS circuitry, at least one communication receiver device and/or the at least one communication transmitter device and/or the at least one communication transmitter/receiver device employing at least one of Wi-Fi, radio wave and/or electromagnetic radiation, Bluetooth.

13. The invention of claim 1 with products removably attached to said cart which additional comprises at least one of a power source, at least one sensor for activation and/or automatic and/or continuous light show, sound, and/or bubble production, projection, and/or edge lighting.
